(19) United States
(12) Patent Application Publication
(10) Pub. No.: US 2004/0137786 A1
(43) Pub. Date: Jul. 15, 2004

(54) BATTERY CONNECTOR WITH MULTI-CONTACT POINT CONTACT STRUCTURE

(76) Inventor: Wei Yu, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/651,925

(22) Filed: Aug. 29, 2003

(30) Foreign Application Priority Data
Dec. 6, 2002 (TW) 91219763

(51) Int. Cl. H01R 3/00

(52) U.S. Cl. 439/500

(57) ABSTRACT

The battery connector (1) comprises an insulative housing (2). The housing comprises a bottom surface (210) and a plurality of peripheral side walls (22). The bottom surface and the side walls cooperatively define a cavity (21) therebetween for receiving a coin battery therein (5). The bottom surface defines a recess (212) below and in communication with the cavity, for accommodating a first contact (3). The first contact comprise a flat contact portion (310 for connecting with the coin battery, a tail portion (32) for engaging with the printed circuit board, and a connecting portion (33) interconnecting the contact portion and the tail portion. The contact portion has a generally flat looped configuration. A plurality of raised contact points (310) is provided on the contact portion at uniform intervals.

### BACKGROUND OF THE INVENTION

1. Field of the Invention

The present invention relates to a battery connector, and more particularly to a coin battery connector.

2. Description of Prior Art

Disk-shaped coin batteries are widely used in electronic equipments, such as computers, as additional power source or back up power source. Although there are a variety of coin batteries of different sizes available, most of them are very small and are thus sometimes referred to as “button batteries”. The coin battery has two major surfaces respectively forming positive and negative electrodes. The positive electrode also extends to a circumferential edge of the disk-shaped coin battery.

The coin battery is mounted and electrically connected to a circuit board via a battery connector. The battery connector comprises a housing defining a center cavity for receiving the coin battery. The housing comprises conductive terminals for contacting with positive and negative electrodes of the battery and electrically connected to the circuit board. This kind of conventional coin battery connector is shown in U.S. Pat. No. 5,980,309, TW Patent Nos. 391571, 291187 and 440071.

As illustrated in FIGS. 5-6, a conventional battery connector 6 comprises an insulative housing 61, and a first contact 62 and a second contact 63 for connecting with a positive electrode and a negative electrode of the battery 7 respectively. The housing 61 comprises a round cavity 610 for receiving the coin battery 7 therein. The first contact 62 extends upwardly from one side of the round cavity 610 to an opposite side of the cavity to form a cantilevered contact portion 620, and the contact portion 620 protrudes up beyond the bottom of the cavity 610 to contact with the battery 7.

However, one problem with this type of battery connector 6 is that the cantilevered contact portion 620 of the first contact 62 is adjacent to one edge of the round cavity 610, and the contact points are almost in the same position, therefore the battery is liable to incline when it is mounted in the cavity at an oblique angle, or is subjected to shock or vibration, such as during shipping.

Therefore, an improved battery connector is required to overcome the above-mentioned disadvantages of the prior art.

### SUMMARY OF THE INVENTION

Accordingly, an object of the present invention is to provide a battery connector having improved contact portion which defines a plurality of contact points, thereby ensuring the reliable connection between the coin battery and the first contact of the battery connector.

To achieve the above-mentioned object, an battery connector with multi-contact point contact structure is provided by the present invention. The battery connector comprises an insulative housing. The housing comprises a bottom surface and a plurality of peripheral side walls. The bottom surface and the side walls cooperatively define a cavity therebetween for receiving a coin battery therein. The bottom surface defines a recess below and in communication with the cavity, for accommodating the first contact. The first contact comprise a flat contact portion for connecting with the coin battery, a tail portion for engaging with a printed circuit board, and a connecting portion interconnecting the contact portion and the tail portion. The contact portion has a generally flat looped configuration. A plurality of raised contact points is provided on the contact portion at uniform intervals. The contact points protrude up beyond the bottom surface into the cavity. Thus, the battery connects the first contact by a plurality of uniform contact points, and a reliable connection will be achieved even if the coin battery is mounted in the cavity at an oblique angle, or if the combined battery connector and coin battery is subjected to shock or vibration such as during shipping.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a battery connector with contacts exploded therefrom in accordance with a preferred embodiment of the present invention;

FIG. 2 is an isometric view of the assembled battery connector of FIG. 1;

FIG. 3 is an isometric view of the battery connector of the present invention with a battery mounted therein;

FIG. 4 is a side view of the battery connector illustrating how the first contact engaging with the battery, but showing only the first contact and the battery;

FIG. 5 is an isometric view of a conventional battery connector with contacts exploded therefrom; and

FIG. 6 is a side view of the conventional battery connector illustrating how the first contact engaging with the battery, but showing only the first contact and the battery.

### DETAILED DESCRIPTION OF PREFERRED EMBODIMENT OF THE INVENTION

Reference will now be made to the drawings to describe the present invention in detail.

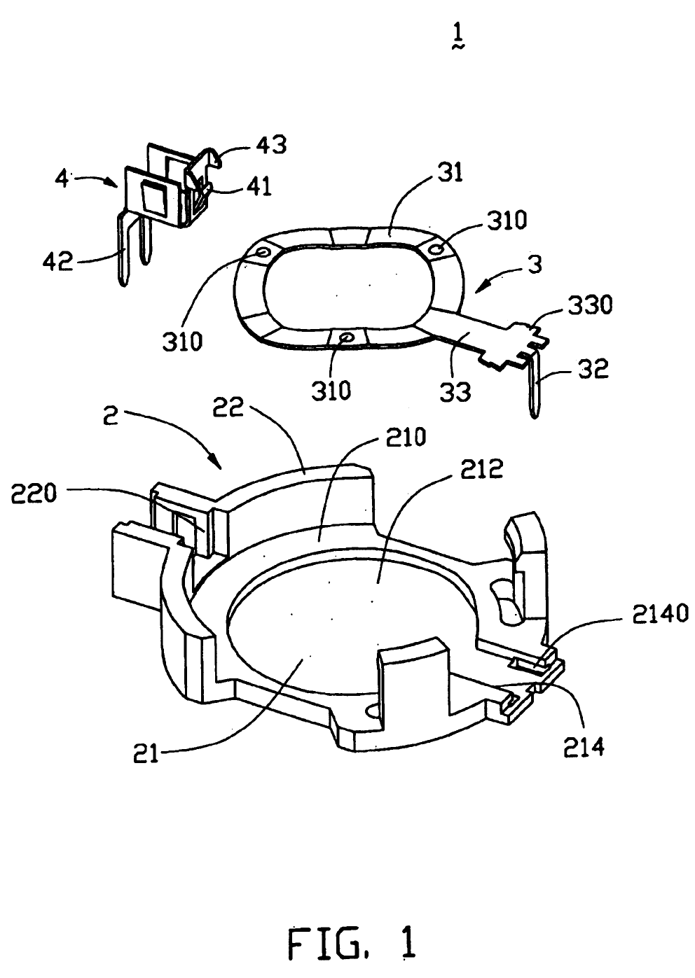

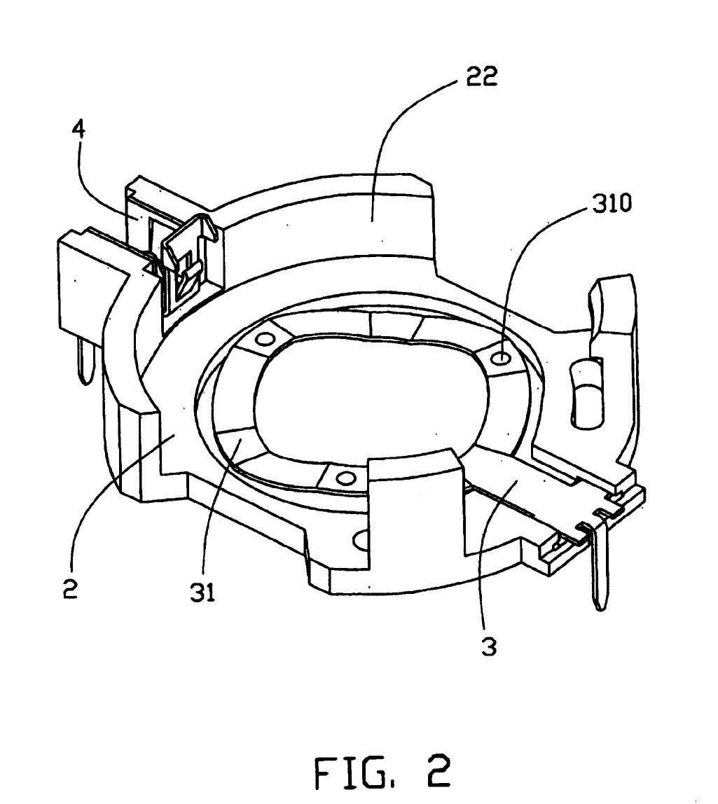

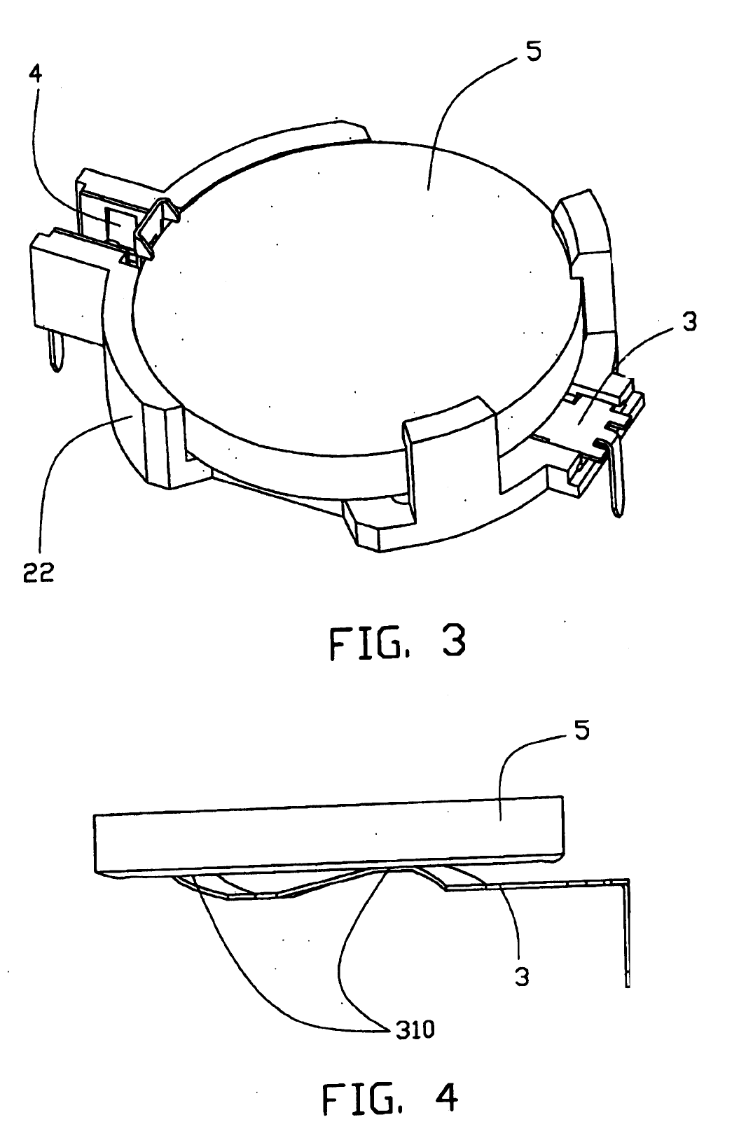

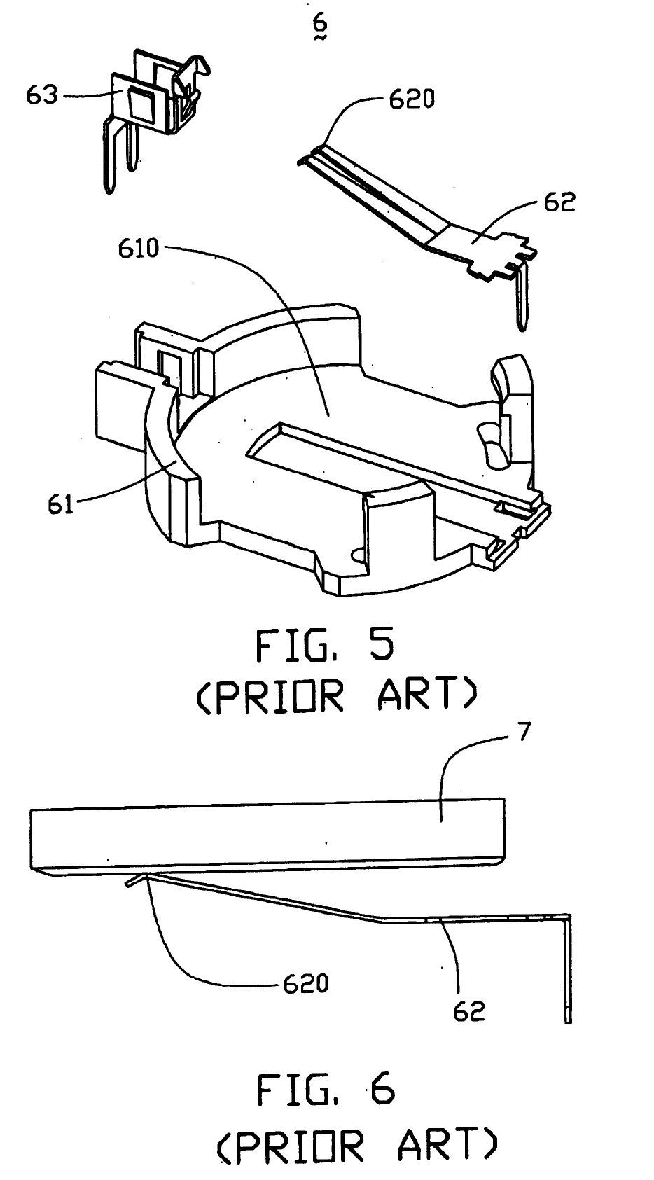

Referring to FIGS. 1-3, a battery connector 1 in accordance with the preferred embodiment of the present invention is adapted for electrically connecting a coin battery 5 to a printed circuit board (not shown). The battery connector 1 comprises an insulative housing 2, and a first contact 3 and a second contact 4 for connecting with a positive electrode and a negative electrode of the coin battery 5 respectively.

The insulative housing 2 comprises a bottom surface 210 and a plurality of peripheral side walls 22. The bottom surface 210 and the side walls 22 cooperatively define a cavity 21 therebetween for receiving the coin battery 5 therein. The bottom surface 210 defines a recess 212 below and in communication with the cavity 21, for accommodating the first contact 3. The recess 212 comprises a channel 214 spanning to a peripheral edge of the bottom surface 210. A pair of orientation grooves 2140 is defined in the housing 2 in communication with the channel 214, for fixing of the first contact 3 thereat.

The side walls 22 of the cavity 21 are separate from each other, and in the preferred embodiment comprise two longer side walls 22 and two shorter side walls 22. The channel 214 is disposed generally between the two shorter side walls 22. A slot 220 is defined between the longer side walls 22, for fixing the second contact 4 therein. Each of the two shorter side walls 22 comprises an inwardly extending retention flange for secure receipt of the battery in the cavity.

The first contact 3 comprise a flat contact portion 31 for connecting with the coin battery 5, a tail portion 32 for engaging with the printed circuit board (not shown), and a connecting portion 33 interconnecting the contact portion 31 and the tail portion 32. The contact portion 31 has a generally flat looped configuration. In the preferred embodiment, the loop is closed. A plurality of raised contact points 310 is provided on the contact portion 31 at uniform intervals. The connecting portion 33 corresponds to the channel 214 of the housing 2. A pair of barbs 330 is formed on each of opposite side edges of the connecting portion 33, for being interferentially engaged in the orientation grooves 2140 and thereby fixing the first contact 3 in the housing 2. The tail portion 32 is depends perpendicularly from the connecting portion 33.

In alternative embodiments, the contact portion 31 of the first contact 3 may be configured to have a semi-annular structure or a curved structure. In either case, the contact points 310 are uniformly distributed along the contact portion 31.

The second contact 4 comprises an elastic portion 41 for connecting with the coin battery 5, a mating portion 42 for engaging with the printed circuit board, and a retaining portion 43 for securing the coin battery 5 in the cavity 21. The second contact 4 is fixed in the slot 220 between the longer side walls 22.

In assembly, the contact portion 31 of the first contact 3 is received in the recess 212 of the bottom surface 210 of the cavity 21, with the connecting portion 33 being fixed in the channel 214 by the barbs 330. In this position, the contact points 310 protrude up beyond the bottom surface 210 into the cavity 21. The second contact 4 is fixed in the slot 220, with the retaining portion 43 protruding into the cavity 21.

Referring also to FIG. 4, in use, the coin battery 5 is secured in the cavity 21 of the housing 2. The negative electrode of the coin battery 5 is located in a side surface thereof, and connects with the second contact 4. The positive electrode of the coin battery 5 is located in a bottom thereof, and connects with the first contact 3. The uniformly distributed contact points 310 of the contact portion 31 provide stable contact with the coin battery 5, even if the coin battery 5 is mounted in the cavity 21 at an oblique angle, or if the combined battery connector 1 and coin battery 5 is subjected to shock or vibration such as during shipping.

The multiple contact points 310 provide reliable connection with the coin battery 5, thereby ensuring reliable mechanical and electrical connection between the coin battery 5 and the battery connector 1.

While preferred embodiments in accordance with the present invention have been shown and described, equivalent modifications and changes known to persons skilled in the art according to the spirit of the present invention are considered within the scope of the present invention as defined in the appended claims.

What is claimed is:

1. A battery connector adapted to receive a coin battery, the battery connector comprising:
an insulative housing comprising a bottom surface and a plurality of side walls cooperatively defining a cavity for receiving the coin battery therein, the housing defining a slot and a recess;
a first contact retained in the recess, the first contact comprising a contact portion for connecting with one electrode of the coin battery, a tail portion for engaging with the printed circuit board, and a connecting portion interconnecting the contact portion and the tail portion; and
a second contact retained in the slot for connecting with another electrode of the coin battery;
wherein the contact portion of the first contact has a looped configuration, with a plurality of contact points provided thereon;
whereby reliable connection between the first contact and the coin battery is achieved.

2. The battery connector as claimed in claim 1, wherein the first contact comprises a closed loop portion.

3. The battery connector as claimed in claim 1, wherein the recess is defined in the bottom surface of the housing, below and in communication with the cavity.

4. The battery connector as claimed in claim 3, wherein the recess comprises a channel spanning to a peripheral edge of the housing.

5. The battery connector as claimed in claim 5, wherein the housing defines a pair of grooves in communication with the channel, and the connecting portion of the first contact comprises a plurality of barbs interferentially received in the grooves.

6. The battery connector as claimed in claim 1, wherein the side walls are separate from each other.

7. The battery connector as claimed in claim 6, wherein the channel is disposed generally between two side walls.

8. The battery connector as claimed in claim 6, wherein the slot is defined between two separate side walls.

9. A battery connector adapted to receive a coin battery, the battery connector comprising:
an insulative housing comprising a bottom surface and a plurality of side walls cooperatively defining a cavity for receiving the coin battery therein, the housing defining a slot and a recess;
a first contact retained in the recess, the first contact comprising a contact portion for connecting with one electrode of the coin battery, a tail portion for engaging with the printed circuit board, and a connecting portion interconnecting the contact portion and the tail portion; and
a second contact retained in the slot for connecting with another electrode of the coin battery;
wherein the contact portion of the first contact has a generally flat configuration, but with a plurality of offset contact points;
whereby reliable connection between the first contact and the coin battery is achieved.

10. The battery connector as claimed in claim 9, wherein the first contact has a looped configuration.

11. The battery connector as claimed in claim 9, wherein the first contact has a semi-annular configuration.

12. The battery connector as claimed in claim 9, wherein the first contact has a curved configuration.

13. The battery connector as claimed in claim 9, wherein the recess comprises a channel spanning to a peripheral edge of the housing.

14. The battery connector as claimed in claim 13, wherein the housing defines a pair of grooves in communication with the channel, and the connecting portion of the first contact comprises a plurality of barbs interferentially received in the grooves.

15. The battery connector as claimed in claim 9, wherein the side walls are separate from each other.

16. The battery connector as claimed in claim 15, wherein the channel is disposed generally between two side walls.

17. The battery connector as claimed in claim 9, wherein the slot is defined between two separate side walls.

18. A connector assembly comprising:
an insulative housing defining a receiving space, a contact disposed in the housing and including a contact portion with a continuous wave-like structure thereof to provide a plurality of upwardly offset contact points thereof; and
a battery received in the receiving space and defining a contact face downwardly pressing upon said contact points of said contact portion to have said contact portion to be in a compressed manner.

19. The connector assembly as claimed in claim 18, wherein said contact portion extends along a periphery of a circle.

20. The connector assembly as claimed in claim 19, wherein said contact portion defines a closed loop.
